(19) United States
(12) Patent Application Publication
(10) Pub. No.: US 2005/0100320 A1
(43) Pub. Date: May 12, 2005

(54) Device and method for recording a media transmission for later playback

(76) Inventors: William Robert Haas, Fort Collins, CO (US); Kirk Steven Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/706,566

(22) Filed: Nov. 11, 2003

(51) Int. Cl. H04N 5/76

(52) U.S. Cl. 386/83; 725/58

(57) ABSTRACT

A media recording device comprises a receiver operable to receive a broadcast signal comprising a media transmission, a storage device operable to continuously store the received media transmission, a user input device operable to receive an input from a user indicative of a date and time occurring in the past for playback of the stored media transmission, and a playback device operable to play back stored media transmission beginning at the user-provided date and time.

### BACKGROUND

Radio, television or other media consumers often find particular media transmissions of interest but are unable to tune into the program transmission during the program broadcast for any number of reasons, such as programs broadcast when the consumer is at work or otherwise unavailable to listen to the program transmission. Magnetic cassette decks or video cassette recorders (VCRs) may be used by the consumer to record a particular program transmission for later playback. However, these recording devices require the user to manually actuate the tape deck or “program” the VCR, thus providing little assistance to consumers that were not prepared in advance of the broadcast program. Additionally, magnetic cassette tapes provide inferior recording quality relative to modern digital media storage devices. Magnetic tapes suffer from additional quality degradation over the life of media stored thereon.

### SUMMARY

Because a consumer of media broadcast services, such as radio or television, often does not know or become aware of broadcast programs until after it has already been aired, it is desirable to provide the consumers the capability to “call up” or otherwise retrieve, for viewing or listening, a program that had already been broadcast. Prior to the solutions presented herein, the consumer was left with the options of waiting for a rerun of the program, waiting for the program to be released in a DVD (digital versatile disc) set, or hoping that a friend or family member had recorded the program. Embodiments of the present invention provide for a continuous recording of one or more channels without requiring the consumer to program a recording device in advance of the program broadcast time.

In accordance with an embodiment of the present invention, a media recording device comprises a receiver operable to receive a broadcast signal comprising a media transmission, a storage device operable to continuously store the received media transmission, a user input device operable to receive an input from a user indicative of a date and time occurring in the past for playback of the stored media transmission, and a playback device operable to play back stored media transmission beginning at the user-provided date and time.

In accordance with another embodiment of the present invention, a method of media transmission playback comprises continuously receiving a broadcast signal comprising a media transmission, continuously storing the received media transmission, receiving a user input indicative of a date and time occurring in the past, and playing back the stored media transmission beginning at the received date and time.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a media receiver having record and playback functionality according to an embodiment of the present invention;

FIGS. 2A and 2B are respectively a simplified schematic of a bit stream output by an analog-to-digital converter and an exemplary compressed digital signal provided by encoding of the bitstream suitable for storage on storage device according to an embodiment of the present invention; and

FIG. 3 is a simplified front schematic of a media recording device according to an embodiment of the present invention.

### DETAILED DESCRIPTION OF THE DRAWINGS

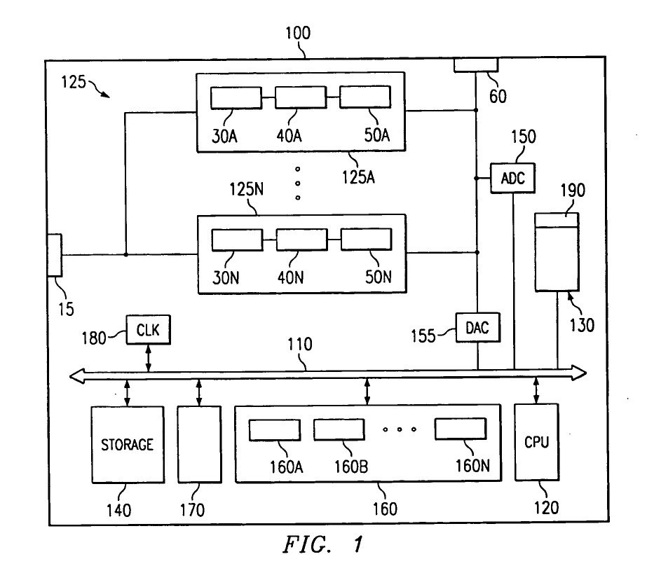

The preferred embodiment of the present invention and its advantages are best understood by referring to FIGS. 1 through 3 of the drawings, like numerals being used for like and corresponding parts of the various drawings.

FIG. 1 is a simplified block diagram of a media receiver 100 having record and playback functionality according to an embodiment of the present invention. Media receiver 100 comprises one or more receiving devices or circuits 125A-125N (collectively referred to as receiving devices 125) that respectively comprise a tuner 30A-30N, a demodulator 40A-40N, and/or an amplifier 50A-50N. Receiving devices 125 are coupled to an antenna input 15, which may be coupled to an antenna. The tuner is operable to separate a signal received at a desired frequency from a plurality of signals received over the operational bandwidth of the antenna. Tuner 30A-30N passes the desired frequency signal to demodulator 40A-40N where an information signal (also referred to herein as a program transmission) is separated from a carrier signal, as now known or later developed. The information signal output by demodulator 40 may then be input to an amplifier 50 and provided to an output device, such as a loudspeaker, via an output interface 60. Receiving devices 125 may receive radio, television, satellite, and/or other media broadcast signals. Receiving devices 125 are preferably coupled with an analog-to-digital converter (ADC) 150 and supply a received signal in an analog format thereto. ADC 150 is operable to convert an analog source signal from receiving devices 125 into a digitally-formatted signal, such as a pulse code modulated (PCM) bitstream, suitable for storage on a digital storage device 140, e.g., a magnetic disk, optical disk, or another device.

A processing element 120, such as a central processing unit (CPU), communicates with and directs operation of various components of receiver 100 via a local interface 110 (e.g., one or more buses) and directs writing of the digitally-formatted signal to storage device 140. Additionally, an encoder may be executed by a processing element 120. Process element 120 may supply the digitally-formatted signal to the encoder for compression and conversion into a compressed digital signal. The compressed digital signal may then be written more efficiently to storage device 140. During playback, the compressed digital signal is supplied to a decoder for converting into a non-compressed digital bitstream, such as PCM data, that may be supplied to a digital-to-analog converter 155 for conversion into an analog signal suitable for output by receiver 100.

A memory unit 130 is addressable by processing element 120 for storing data. Memory unit 130 may be implemented as any one of various devices that can hold data in a machine-readable format, such as a random access memory (RAM), a read-only memory (ROM), or an erasable, programmable, read-only memory (EPROM or Flash memory) now known or later developed.

Receiver 100 further comprises an input device 160, for example a control panel having one or more keys, buttons, dials or other input elements 160A-160N, that are used by a user to input data, such as control commands. An output device 170, for example a liquid crystal display element or another device operable to provide visual output to a user, is used to output data to the user.

The user may tune receiver 100 to a desired frequency by providing a tuning command to input device 160 according to an embodiment of the present invention. The tuning command is received by input device 160 and provided to processing element 120. Processing element 120 directs one receiving device 125 to tune to the frequency indicated by the input tuning command. Processing element 120 may also direct output device 170 to provide a visual indication of the tuned frequency. Accordingly, a signal received by receiver device 125 via input 15, is filtered, demodulated, amplified, and then passed to output interface 60, for example an audio output that interconnects with a headphone or loudspeaker.

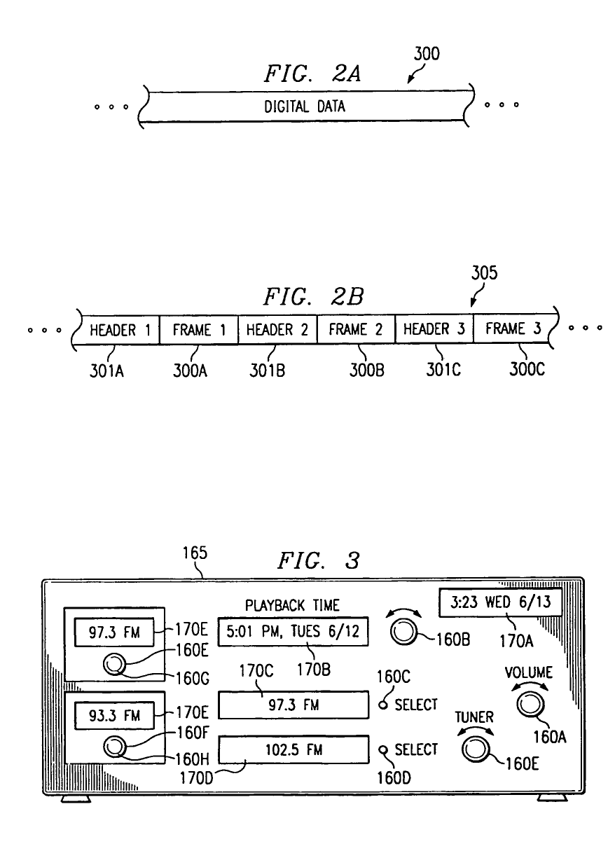

Processing element 120 continuously directs the recording of programming on one or more channels or radio frequencies selected by the user. With reference now to FIGS. 2A and 2B, there is respectively a simplified schematic of a digital bit stream 300 output by an analog-to-digital converter (ADC) 150 and an exemplary compressed digital signal 305 provided by encoding of bitstream 300 suitable for storage on storage device 140 according to an embodiment of the present invention. Digital bit stream 300 and compressed digital signal 305 represent the content of programming on a particular channel that is recorded for playback. A demodulated signal may be input into ADC 150 from receiver circuit 125, optionally compressed (or otherwise encoded), and the resulting digital signal 305 written to storage device 140. ADC 150 is operable to sample the demodulated analog signal output by demodulator 40A-40N and convert the sampled analog signal into a digital bitstream 300 of binary values, such as pulse code modulated data, that are storable on storage device 140.

Digital bitstream 300 may be subjected to various processing and/or conversion procedures by processing element 120 prior to writing the processed digital signal to storage device 140. For example, bitstream 300 may be compressed or otherwise encoded, into a compressed digital signal 305 (for example into an MPEG-1 audio layer 3 format), to conserve storage volume of storage device 140. Additionally, the compressed digital signal 305 may be subdivided into a plurality of frames 300A-300C and at least a portion of frames 300A-300C may have a header 301A-301C associated therewith. Information, such as compression identification, synchronization information, or other data, may be stored in header 301A-301C that facilitates proper decompression and playback of the compressed digital signal 305. Information, such as the frequency (channel) from which the compressed signal was originally obtained, time of reception of the program transmission, or other data, is preferably stored in one or more headers of compressed digital signal 305 as well. Signal 305 is preferably written to storage device 140 for later playback. Receiver 100 preferably has a digital-to-analog converter (DAC) 155 coupled to local interface 110 for converting digitized media stored on storage device 140 to a suitable analog format prior to output via output interface 60.

With reference now to FIG. 3, there is a simplified front schematic of receiver 100 according to an embodiment of the present invention. Receiver 100 preferably includes a plurality of output devices, such as output display devices 170A-170F, disposed on a front panel 165 thereof. Output device 170A may display current date and time information provided by device clock 180 that is maintained in hardware or software of device 100. A playback output device 170B provides a visual output of a selected program airtime that is currently selected for playback. In the exemplary diagrammatic illustration, playback output device 170B indicates the selected program airtime being played corresponds to a program transmission airtime of Tuesday, June 12, 5:01 p.m. One or more tuner output display devices 170C and 170D are disposed on front panel 165 for displaying a selectable output frequency for playback. In the illustrative example, tuner output display device 170C indicates a radio-frequency of 97.3 FM is selected for playback and tuner output display device 170D indicates a radio-frequency of 102.5 FM is selected for playback. Additionally, one or more record output devices 170E and 170F may be disposed on front panel 165 for providing a visual indication of a currently selected channel, such as an FM radio channel, for recording by receiver 100.

One or more of output devices 170A-170F may have at least one input device operatively coupled thereto for providing input to control or direct operation of receiver 100. For example, an input device 160B may enable a user to select a desired playback time of a recorded program. Input device 160B is preferably implemented as a rotatable dial that is rotatable in both a clockwise and counterclockwise direction. In a playback mode of operation, rotation of input device 160B in one direction, such as a clockwise direction, results in a “fast-forward” or “skip” procedure being performed on digital signal 305 stored in storage device 140 such that play of the selected recorded program is forwarded an amount relative to the amount of rotation imparted to input device 160B. Similarly, rotation of input device 160B in a counter-clockwise direction results in a “rewind” or “replay” procedure being performed on digital signal 305. Buttons with directional icons may also be used to select the date and time. Receiver 100 is therefore operable to playback the programming that was broadcast in the past without requiring the user to “program” receiver 100 to record the programming prior to or concurrently with the broadcasting of the program. Each input device 160E and 160F is associated with one digital compressed bit stream stored in storage device 170.

While the exemplary front panel 165 is configured to facilitate control of receiver 100 having capabilities of simultaneously recording two selected channels, it should be understood that the concepts of the present invention are not limited to recordation of any particular number of channels, and receiver 100 may be implemented to only record a single channel or may be configured to concurrently record two or more channels.

An exemplary procedure for directing receiver 100 to record a program transmission may be performed as follows. The user selects a favorite or desired frequency, or channel, by inputting the desired frequency into tuner input device 170E. For example, the user may desire to record program transmissions broadcast on 97.3 FM by dialing tuner input device 160E. The desired frequency is displayed on output device 170E. Receiver 100 is preferably configured to provide a plurality of outputs for displaying multiple channels selected for recording and, accordingly, each tuner input device 160E and 160F may have a respective selection button 160G and 160H for activating the associated input device. For example, prior to inputting a desired frequency for recording by dialing input device 160E, the user may activate input device 160E and record output device 170E by activating a selection button 160G associated therewith. After input of a desired recording frequency and actuation of selection button 160G, the frequency input to record input device 160E may be conveyed to processing element 120 as a tuning command and processing element 120 may direct receiving device 125A to tune to the frequency indicated by the tuning command and may invoke recording application 190 to record a broadcast received thereby. As described hereinabove, the received program transmission may be encoded prior to writing thereof to storage device 140. Recording of a program transmission according to the described technique may be performed continuously until receiver 100 is powered off.

Unlike conventional recording devices such as video cassette recordings and digital video recorders, the user does not have to provide input as to the program or other information prior to the broadcast of the program. The user selects his/her favorite channels or stations and receiver 100 automatically records broadcast programming on the selected channels. The recording is only limited by the amount of storage available and is operable to write over the oldest recorded materials. The recording continues indefinitely.

Returning again to FIG. 3, a playback mode of receiver 100 may be initiated for playback of recorded frames 300A-300N (or a portion thereof) by selection of a desired frequency and origination time for playback. For example, the user may actuate select input device 160C and input a desired frequency (by dialing a desired frequency via tuner input device 160E) for playback of an earlier recorded program transmission. Alternately, the user may simply actuate one of buttons 160C and 160D so that the respective displays 170C and 170D associated therewith display the favorite channels or stations previously selected by the user. A desired time of origination may be input by, for example, dialing the desired origination time by rotating input device 160B. The origination time input by the user and displayed on playback output device 160B may comprise a day, date, and/or time of origination. Upon input of a desired program transmission playback, the input origination time and frequency are conveyed to recording application 190. Recording application 190 uses the origination time and/or frequency as operands to search the stored digital bit stream. Recording application 190 searches headers 301A-301C for the desired timestamp of the selected program. The frame associated with the headers 301A-301N determined to have timestamp data most proximate the desired playback time is selected by recording application 190 as the first frame for decoding; playback proceeds with sequential frames thereafter decoded and output for playback. Other techniques for addressing and retrieving frames 300A-300N based on a desired origination time for playback are possible and the particular technique described is exemplary only.

Receiver 100 enables a user to retrieve and enjoy a program that had been broadcasted in the past without requiring the user to program the recording thereof in advance of the broadcast. Therefore, a user may, upon discovering that she had missed a particular program that had been aired on one of her favorite channels/stations, instruct receiver 100 to playback that program from storage device 140 (FIG. 1) and view/or listen to the program. Storing broadcast programming in this manner, the users also do not need to contend with the disadvantages of magnetic cassette tapes, such as inferior recording quality and degradation of the tape as well as the recorded material over time.

1-28. (canceled)

29. A media recording device, comprising:
a receiver operable to receive a broadcast signal comprising a media transmission;
a storage device operable to continuously store the received media transmission;
a user input device operable to receive an input from a user indicative of a date and time occurring in the past for playback of the stored media transmission; and
a playback device operable to play back stored transmission beginning at the user-provided date and time.

30. The device, as set forth in claim 29, wherein the user input device comprises a dial rotatable in a counter-clockwise direction for indicating a playback time and date occurring in the past.

31. The device, as set forth in claim 29, wherein the user input device further comprises a display operable to display a time and date occurring in the past corresponding to an amount of dial rotation.

32. The device, as set forth in claim 29, further comprising a processor operable to search the storage device for a received media transmission associated with a date and time matching the user-provided date and time, and provide the media transmission matching the user-provided date and time to the playback device.

33. The device, as set forth in claim 29, wherein the playback device comprises an audio output.

34. The device, as set forth in claim 29, wherein the playback device comprises a video output.

35. The device, as set forth in claim 29, wherein the storage device is operable to store a predetermined amount of continuous media transmission for playback.

36. The device, as set forth in claim 29, further comprising a second receiver operable to receive media transmission broadcast over a second channel for storage in the storage device.

37. The device, as set forth in claim 29, further comprising an analog-to-digital converter operable to convert the media transmission from an analog format received by the receiver to a digital format for storage by the storage device.

38. The device, as set forth in claim 29, wherein the receiver is operable to receive broadcast radio signals.

39. The device, as set forth in claim 29, wherein the receiver is operable to receive broadcast television signals.

40. A method of media transmission playback, comprising:
continuously receiving a broadcast signal comprising a media transmission;
continuously storing the received media transmission;
receiving a user input indicative of a date and time occurring in the past; and
playing back the stored media transmission beginning at the received date and time.

41. The method, as set forth in claim 40, further comprising receiving a user input indicative of at least one desired broadcast channel and continuously receiving broadcast signal of the at least one desired broadcast channel.

42. The method, as set forth in claim 40, further comprising displaying the user-provided time and date occurring in the past.

43. The method, as set forth in claim 40, further comprising searching the storage device for a received media transmission associated with a date and time matching the user-provided date and time, and providing the media transmission matching the user-provided date and time for playback.

44. The method, as set forth in claim 40, wherein playing back the stored media transmission comprises providing an audio output.

45. The method, as set forth in claim 40, wherein playing back the stored media transmission comprises providing a video output.

46. The method, as set forth in claim 40, wherein continuously storing the received media transmission comprises storing media transmission received in the past predetermined number of hours.

47. The method, as set forth in claim 40, wherein continuously storing the received media transmission comprises writing over media transmission received beyond a past predetermined number of hours.

48. The method, as set forth in claim 40, wherein continuously storing the received media transmission comprises storing media transmission received in the past predetermined number of days.

49. The method, as set forth in claim 40, wherein continuously storing the received media transmission comprises writing over media transmission received beyond a past predetermined number of days.

50. The method, as set forth in claim 40, further comprising receiving media transmission broadcast over a second channel and continuously storing the received media transmission.

51. The method, as set forth in claim 40, further comprising converting the received media transmission from an analog format to a digital format for storing.

52. The method, as set forth in claim 40, wherein continuously receiving a broadcast signal comprises receiving broadcast radio signals.

53. The method, as set forth in claim 40, wherein continuously receiving a broadcast signal comprises receiving broadcast television signals.

54. The method, as set forth in claim 40, wherein continuously storing the received media transmission comprises storing a date and time associated with the received media transmission.

55. The method, as set forth in claim 40, wherein continuously storing the received media transmission comprises storing a broadcast channel identification associated with the received media transmission.
